(19) United States
(12) Patent Application Publication
(10) Pub. No.: US 2009/0059906 A1
(43) Pub. Date: Mar. 5, 2009

(54) ROUTING OF TELECOMMUNICATIONS

(76) Inventor: Eamon M. Cullen, Belfast (GB)

Correspondence Address: NIXON & VANDERHYE, PC, 901 NORTH GLEBE ROAD, 11TH FLOOR, ARLINGTON, VA, 22203, US

(21) Appl. No.: 12/282,206

(22) PCT Filed: Feb. 9, 2007
(86) PCT No.: PCT/GB2007/000463

§ 371 Date: Sep. 9, 2008

(30) Foreign Application Priority Data
Mar. 30, 2006 (EP) 06251775.0

(51) Int. Cl. H04L 12/66

(52) U.S. Cl. 370/352

(57) ABSTRACT

A gateway (11) is arranged to control the routing of a telecommunications call such that it may be handled in one of two or more alternative modes (3, 4). The gateway (11) identifies the intended routing of a call by way of the PSTN, for example from the dialed digits, and selectively forwards calls either to the PSTN (3) for control by a gatekeeper function (5) that attempts to route calls by another mode such as a packet switching network (4). By inserting the gateway (11) between the originating PBX (10) and the PBX (3), minimal alteration to the existing installation (10) is required.

This invention relates to the routing of telecommunications connections, and in particular the selection of routing for calls over a virtual private network (VPN) according to both call type and destination, to make the most efficient use of the available host networks.

A virtual private network comprises two or more private branch exchanges (PBX) co-operating over a public or other shared network such that users of either PBX perceive the complete system as a single PBX. This allows users' network facilities to be available throughout a distributed network. It also allows calls to or from external parties (not part of the virtual network) to be routed by way of the most efficient PBX—for example by routing the international leg of an outgoing call over a VPN, such that the public network (PSTN) is only used for the connection between the called party and a PBX local to the called party.

Conventional telephony provides a circuit switched connection in which the resources necessary to provide an end-to-end path through the network are reserved for the duration of the call. Such resources may include a complete physical end-to-end wire, but more typically include elements of multiplexing either by frequency or time division. Circuit switched systems are reliable, but require resources to be reserved for the duration of the call, even when fewer resources are necessary to support the instantaneous traffic carried.

The acoustic interfaces with the human speakers and listeners are necessarily analogue signals, but in general the network operators digitise the signals for much of the intermediate path. The conversion may take place in the user terminal, as it does for example in most modern wireless systems such as cellular and cordless telephony, or further into the network, as for example in a typical fixed-line (PSTN) exchange.

Voice over Internet Protocol (VoIP) systems make use of a packet-switched network to carry voice signals between PBXs. In such systems, a voice gateway in each PBX transmits digitised data to another co-operating PBX, together with any signalling overhead, using a technology such as multi-protocol label switching (MPLS). The VOIP system requires fewer resources, because as the amount of information to be transmitted varies, so does the amount of compression capable of being performed on the signal, and thus the number of packets that require transmission. The resources required to support the call can vary dynamically throughout the call, rather than being maintained at a constant, relatively high, value throughout the call as required for a circuit switched call.

At present, not all telephone terminations have a VOIP capability, and VoIP-compatible systems must be provided with the capability to interface with non-VOIP systems to allow connections to be made between a VoIP system and a non-VoIP system. For example, a user of a VoIP-capable PBX may wish to make a call to an external line connected to the PSTN (public switched telephone network). If either termination point of the call does not have VOIP capability, conversion between modes is required somewhere in the network. The need to convert between modes may affect the relative merits of the two systems for the call in question. Moreover, if capacity on one system (VoIP or circuit switched) or the other is limited, it is desirable to select the mode used for each call such that the limited capacity of that system is reserved for the types of call which can benefit most from using that system. For example, if the efficiency gains from using VOIP are greatest for international calls, it may be desirable to limit the use of the VOIP system by non-international calls so that the VOIP system is available for the International calls.

The present invention is a system for controlling the routing of a telecommunications call such that it may be handled in one of two or more alternative modes according to predetermined characteristics of the connection that is to be made. Such characteristics may, typically, include the destination of the connection, determining whether a circuit switched or packet switched option should be selected.

According to the invention there is provided apparatus for controlling the routing of a telecommunications call such that it may be handled in one of two or more alternative modes, comprising a gateway interposed between a communications switch and a communications network operating according to a first mode, for handling calls originating from termination points connected to the switch, the gateway having means for identifying the intended routing of a call, and means for selectively diverting calls for a predetermined set of destinations to a mode other than the routing selected by the communications switch.

According to another aspect, there is provided a method of controlling the routing of a telecommunications call such that it may be handled in one of two or more alternative modes, wherein the intended routing of each call is identified by a gateway interposed between a communications switch and a communications network operating according to a first mode, and selectively diverting calls for a predetermined set of destinations to a mode other than the routing selected by the communications switch

Because the mode by which calls are routed is controlled automatically, users do not need to be aware of the criteria for selecting the optimum mode, and inappropriate selection of one mode instead of another is prevented. The criteria for selecting the modes may be changed according to capacity constraints in the different networks.

In the illustrative embodiment to be discussed, the modes are circuit switched and packet switched—specifically VoIP. Because the gateway monitors the dialed numbers associated with a call, it can select a route for the call (VOIP or PSTN). The use of such a “gateway” allows the provision of VoIP connections between existing PBXs, such that the PBXs can remain otherwise unmodified and the user experience is unchanged. An added advantage is that the selective diversion can be automatic, but with the facility to change or over-ride the selection criteria manually.

The Voice Gateway, connected between the private exchange (PBX) and the public switched network (PSTN), determines the dialed digits of outgoing calls and uses predetermined criteria to route the call, either to the PSTN, or over a VoIP connection using a digital packet network such as ISDN. The criteria may include the recognition of specified dialing codes, such as the “international” prefix, or that for a “virtual private network” call—that is to say, one to be made to another terminal on an associated PBX at another site. The criteria may also include the presence or absence of an over-ride prefix, allowing users to select a routing other than the one that the system would otherwise select. Such prefixes may be used to ensure a call requiring a special application is made on a network supporting that application, or to give privileged access to a particular class of user, for example to allow testing of the system prior to making it available generally. The availability of such over-ride facilities may be controlled by limiting knowledge of the prefixes only to authorised personnel, or by arranging the gateway to allow calls with such prefixes to be made only from certain terminals.

By inserting the gateway between the PBX and the network, rather than modifying the PBX itself, the operation of the PBX is unaffected and the VoIP system can be tested, operated, extended and modified independently of the existing circuit switched system. It also allows users to force a call to be routed by the circuit switched or packet switched route by the provision of access codes recognisable by the gateway. This allows the normal settings to be over-ridden, for example, for test purposes or to allow a call that requires to be routed by other than the default route to be handled accordingly

Each PBX in the virtual network has an associated gateway. However, in a preferred embodiment, control of a plurality of such gateways may be performed by a single controlling engine, referred to below as a gatekeeper function. The Gatekeeper function allows more flexible use of capacity than would be possible if each PBX acted autonomously, since it can have an overview of the total available network bandwidth.

An embodiment of the invention will now be described with reference to the drawings, in which

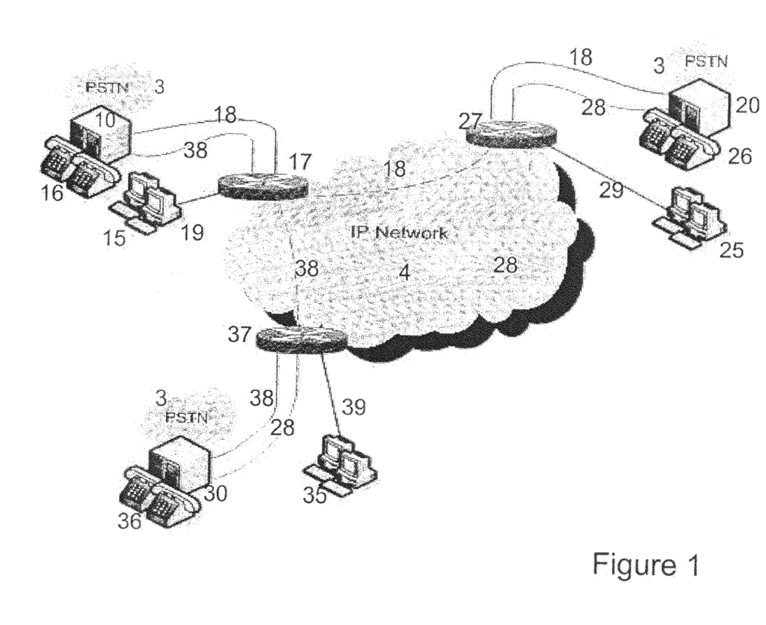

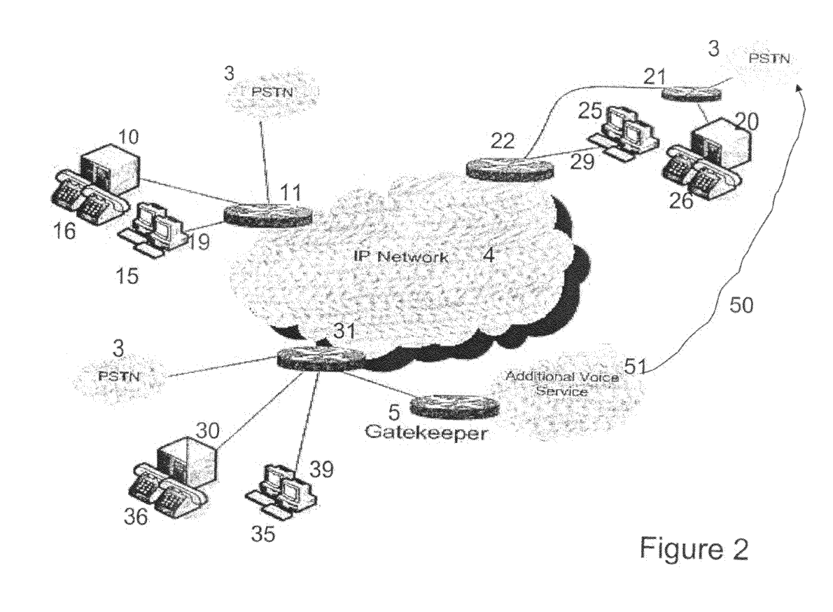

FIG. 1 is a schematic illustration of a VoIP system operating according to the prior art FIG. 2 is a schematic illustration of a simple system operating according to the invention,

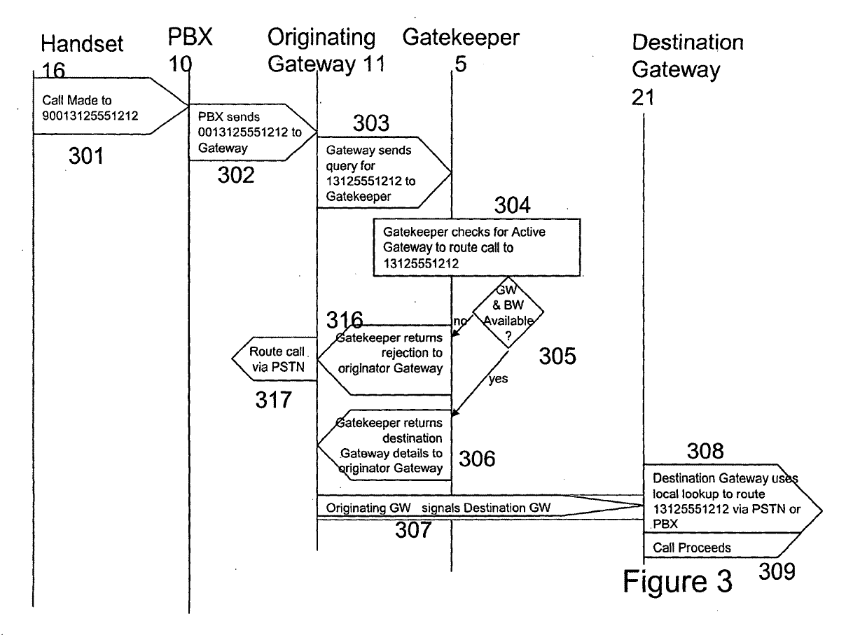

FIG. 3 is a flow diagram illustrating the operation of the system of FIG. 2,

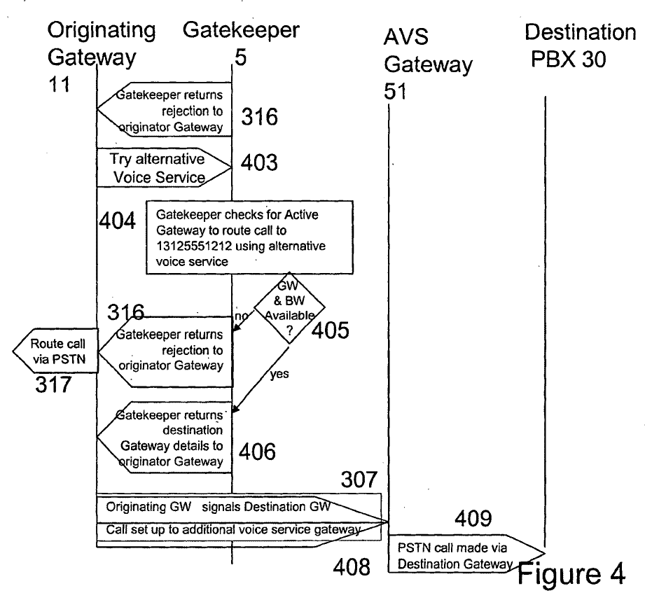

FIG. 4 is a flow diagram further illustrating the operation of the system of FIG. 2,

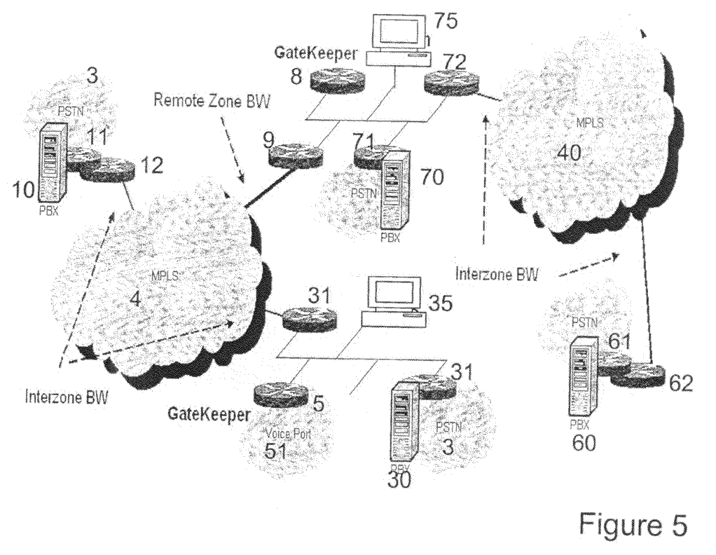

FIG. 5 is a schematic illustration of a more complex system according to the invention.

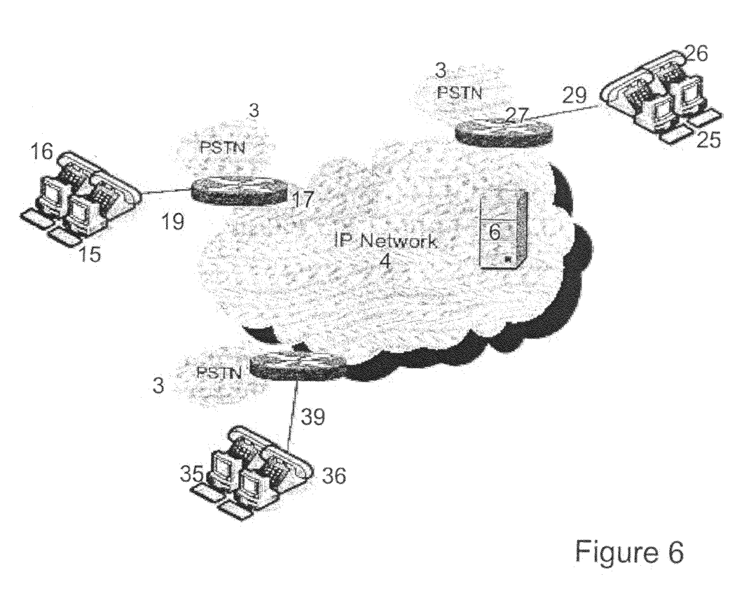

FIG. 6 is a schematic illustration of a fully integrated computer/telephony system

FIG. 1 depicts three PBXs, 10, 20, 30 each having a connection to the PSTN 3. Each location also has an associated local area computer network (LAN) 19, 29, 39, and these are interconnected through respective routers 17, 27, 37 to a packet switching network-4. Telephones 16, 26, 36 are connected to each PBX 10, 20, 30 and computers 15, 25, 35 to each LAN 19, 29, 39.

A fully integrated computer-telephony system is shown in FIG. 6. In this arrangement, the telephony applications 16 are integrated into the computers 15, with a call routing function 6 embodied in the IP network 4. However, to change an existing system such as that described hitherto to a system as depicted in FIG. 6 requires extensive modification of the networks, and in particular to the PBXs. Installation and testing of such changes can be disruptive to the users.

FIG. 1 illustrates one way of adapting an existing network to allow telephone calls to be routed over the packet switched network 4. In this arrangement, trunk connections 18, 28, 38 are provided between each pair of PBXs 10,20; 10,30; 20,30 via their associated routers 17, 27, 37. This allows appropriate calls to be routed through the MPLS network 4. However, such a configuration requires each PBX 10, 20, 30 to be reconfigured to identify calls that may be carried over the MPLS route 4 instead of over the PSTN 3, and to route such calls appropriately. As each PBX 10 in turn is modified by the provision of this facility, so this will affect the routing plans of all the other PBXs 20, 30.

As depicted in FIG. 2, the present invention provides an alternative architecture that requires no modification to the PBXs 10, 20, 30. Inserted into the connection between each PBX 10, 20, 30 and the PSTN 3 is a respective VoIP gateway 11, 21, 31, which in turn gives access both to the PSTN 3 and to the MPLS (Multi-Protocol Label Switching) network 4. As shown for gateway 21, the connection to the MPLS network 4 may be by way of a, second router 22. This arrangement is particularly advantageous where an IP network already exists. For new sites it is more convenient to use a single device 11 (31) to connect the PBX, PSTN and IP Network.

The PBX 10, 20, 30 at each site operates in conventional manner, being configured to present standard PSTN dialing to the associated Voice Gateway 11, 21, 31, and the PBX. The gateways 11, 21, 31 can therefore be installed between the respective PBX 10, 20, 30 and the PSTN 3 without modification to either.

Each gateway is under the control of a gatekeeper function 5, depicted as co-located with one of the gateways 31, and controlling the other gateways through the network 4. The gatekeeper 5 may support additional services such as a voice port 51 providing a connection to a circuit with tariff for international calls.

The gateways 11, 21, 31, under the control of the gatekeeper 5, are arranged to select voice calls for transport across the MPLS system 4. When MPLS is not available end to end, (for example because a call is to be connected to an external line by way of the PSTN 3) conversion to or from analogue voice signal has to be performed at an intermediate point. Each gateway has a dial plan configuration, arranged to query the gatekeeper 5 for calls destined for a first set of predetermined number groups, and to route other calls by way of the PSTN 3. For those calls for which it receives a query, the gatekeeper 5 provides the originating gateway with instructions on how to route those calls across the MPLS network 4.

The dialing plan may make use of publicly available dialing codes, e.g. to route all calls with a given International dialing code by one route or the other. It may also use special over-ride prefix or access codes to allow the default dialing plan in the gateways 11, 21, 31 to be over-ridden, for example to allow only users with the access code to send calls via one or other of the routes 3, 4. Among other uses, this allows the gateways to be installed and tested without affecting other users. It may also be used to over-ride the settings of the dialing plan if for example, a particular call is required to be routed using a circuit switched connection.

One possible dialing plan would define a Zone Prefix for each gateway 11, 21, 31, which identifies telephone numbers available within a zone associated with that gateway. These prefixes may conveniently be the local area code for the site where the gateway is installed. This allows calls to be routed from one site to another across the MPLS network 4. It also allows calls to an external destination (i.e. one not served by a PBX) that is in the same local area as any VoIP Gateway to be routed via MPLS, by way of the gateway sharing the same zone prefix as the destination. This allows the PSTN element of the routing to be limited to the local area. The Zone prefixes can be defined as full international telephone numbers, less the international access codes—thus a zone prefix for Birmingham, UK would be 44121, and that for Birmingham, Ala. would be 1205. This requires that each of the Gateways strip off the relevant international access code from the dialed digits (this varies from country to country, but is usually either 011 or 00) before sending a request to the Gatekeeper.

The operation of the invention will now be described, with reference to FIGS. 2 and 3. Initially, a call attempt 301 is made from a handset associated with a first PBX 10. The PBX 10 sends the call digits forward (less any outside line access code—in the case the initial “9”, of the dialed digits)

However, the call digits do not reach the PSTN 3 as in a conventional system, because they are intercepted by the gateway 11 associated with the PBX 10 (step 302).

The gateway identifies whether the dialed digits it receives relate to a destination number that is to be routed by way of the PSTN 3 or converted to VoIP. For example, using the United Kingdom dialing plan, international calls are preceded by the international access code (00), national (trunk) landline calls by a trunk access code (01 or 02), calls to cellular numbers by another code (07), and local calls are identifiable by being preceded by a digit other than zero.

In the present example, international calls (00 prefix) are routed by way of the MPLS network 4 if possible, and all other calls always by way of the PSTN 3. Consequently, the gateway 11 is configured such that if a number is dialed which is not preceded by the international access code (00), the gateway 11 will forward the call to the PSTN 3. Conversely, in the example shown, an International number 0013125551212 has been dialed—in this case the international access code (00) is removed and the rest of the digits forwarded in the request to the gatekeeper.

The gateway transmits a query 303 for the dialed digit string to the gatekeeper 5. Because the gatekeeper 5 controls the operation of several gateways 11, 21, 31, which may be connected to PBXs 10, 20 30 in different countries, it needs to handle the digits in a standard form. For this reason, the gateways 11, 21, 31 convert the digit string into a form which includes the international or national area codes for the dialed number, but not the international access code, as these may vary from one country to another—usually 00 or 011, or the national access code. The gatekeeper 5 checks whether there is a gateway 21 registered with it that can accept calls having the digit string that has been presented to it (step 304). In general it will not be necessary to analyse the entire string, as individual gateways will handle blocks of numbers—for example a particular gateway 21 may be capable of handling all digit strings in which the first four digits are 1312 (Chicago, USA). The gatekeeper also checks whether there is an operational destination gateway 21, and sufficient capacity available in the MPLS network 4 to support the call (step 305).

If no suitable gateway and network capacity is identified, the gatekeeper 5 returns an instruction 316 to the originator gateway 11 to route the call by way of the PSTN 3 (317). The gateway 11 then forwards the digits it originally received from the PBX 10 (i.e. not the modified string sent to the gatekeeper) to the PSTN 3, and plays no further part in the call.

If a suitable destination gateway 21 is identified, the gatekeeper 5 returns the details (306) of this destination gateway 21 to the originator gateway 11 (step 306). The originating gateway 11 then signals the destination gateway 21 in order to establish communications between them (step 307). The destination gateway 21 then uses a look up table (step 308) to identify the local routing for the call (typically by removing the international and/or local dialing codes) and forwards the call (step 309) either to the associated PBX 20 (if the called line is connected to the PBX) or otherwise to the PSTN 3 for forwarding locally. This latter arrangement allows calls to be trunked over the MPLS 4 network, using the PSTN 3 only for the local connection.

A modified process will now be described, with reference to FIG. 4. In this scenario, a private circuit-switched connection 50 is available between the destination gateway 21 and another gateway 31—depicted in FIG. 2 as being the gateway co-located with the gatekeeper 5.

The process is the same as that of FIG. 3 up to the point where the gatekeeper 5 returns a rejection 316 to the originating gateway 11.

Instead of next attempting a routing by way of the PSTN 3 (317), the gateway 11 first requests the gatekeeper 5 to seek an alternative routing (step 403) The Gatekeeper 5 now attempts to identify any circuit switched connections which may be made between the destination PBX 30 and another gateway (step 404). In this case it identifies the link 50, between the additional voice service gateway 51 and the PBX 30. Such a link, to be suitable, would provide access through the PSTN 3 in the locality of the destination PBX 30. The gatekeeper 5 again checks the available bandwidth (step 405) and returns an acceptance (406) to the originator gateway. If suitable bandwidth has been identified between the gateways 11, 51, the call is routed from the originating gateway 11 to the new destination gateway 51, and thence by the private connection 50 to the intended PBX 30. To achieve this, the originating gateway 11 signals the destination gateway 51 (step 307) as in the previous scenario, and the call 408 is then set up. A PSTN connection is then set up (409) over the link 50 to complete the connection.

In the event that no suitable connection is available either to the destination gateway 21 or by way of an alternative routing 51, the call is routed via the PSTN 3 (steps 316, 317)

FIG. 5 represents a more complex system in which there are two interconnected zones, each similar to the network depicted in FIG. 2. Elements in the first zone have the same reference numerals as in FIG. 2, whilst the second zone is depicted having two PBX 60, 70, with associated gateways 61, 71 and MPLS access points 62, 72 giving access to a second MPLS network 40 and the PSTN 3, under the control of a second gatekeeper 8 associated with one of the PBX 70. As before, computers 35, 75 may be connected to the local networks. To allow communication between the two zones of the virtual network, there is also a connection 9 between the MPLS networks 4, 40, linked to one of the PBXs 70. Effectively, that PBX 70 has connections 9, 72 into both MPLS networks 4, 40.

Calls originating on each network are controlled by the respective gatekeeper 5, 8. Calls between these two zones are limited by the gatekeepers 5, 8 based on the amount of bandwidth available between the two zones (ie the connection 9). In addition to the local gateways in their own zones, the gatekeepers 5, 8 are made aware of each other and of how much bandwidth is available in the connection 9 between the two zones.

1. Apparatus for controlling the routing of a telecommunications call such that it may be handled in one of two or more alternative modes, comprising a gateway interposed between a communications switch and a communications network operating according to a first mode, for handling calls originating from termination points connected to the switch, the gateway having means for identifying the intended routing of a call, and means for selectively diverting calls for a predetermined set of destinations to a mode other than the routing selected by the communications switch.

2. Apparatus according to claim 1, wherein the modes are circuit switching and packet switching

3. Apparatus according to claim 2, wherein the packet switching system incorporates a Voice over Internet (VoIP) capability

4. Apparatus according to claim 1, wherein a default selection criterion is applied, and provision is made to over-ride the default selection criteria manually.

5. Apparatus according to claim 1, wherein a default selection criterion is applied such that if the dialed digits of a call are prefixed with a predetermined code, the gateway attempts to route via a first mode, and otherwise attempts to route by a second mode.

6. Apparatus according to claim 1, wherein a plurality of gateways are associated with a gatekeeper function, the gatekeeper having means to monitor network usage and control the operation of the gateways to optimise usage.

7. A method of controlling the routing of a telecommunications call such that it may be handled in one of two or more alternative modes, wherein the intended routing of each call is identified by a gateway interposed between a communications switch and a communications network operating according to a first mode, and
selectively diverting calls for a predetermined set of destinations to a mode other than the routing selected by the communications switch

8. A method according to claim 7, wherein the modes are circuit switching and packet switching

9. A method according to claim 8, wherein the packet switching system incorporates a Voice over Internet (VoIP) capability

10. A method according to claim 7, wherein a default selection criterion is applied, and provision is made to over-ride the default selection criteria manually.

11. A method according to claim 7, wherein a default selection criterion is applied such that if the dialed digits of a call are prefixed with a predetermined code, the gateway attempts to route via a first mode, and otherwise attempts to route by a second mode.

12. A method according to claim 7, wherein a plurality of gateways are associated with a gatekeeper function, the gatekeeper having means to monitor network usage and control the operation of the gateways to optimise usage.
